(19) United States
(12) Patent Application Publication
(10) Pub. No.: US 2026/0264270 A1
(43) Pub. Date: Sep. 10, 2026

(54) FINGER MODULE, MANIPULATOR, AND ROBOT

(71) Applicant: Beijing Youzhuju Network Technology Co., Ltd., Beijing (CN)

(72) Inventors: Jiajun Zhang, Beijing (CN); Zeyu Ren, Beijing (CN); Zhongren Cui, Beijing (CN); Ruoshi Wen, Beijing (CN); Guangzeng Chen, Beijing (CN); Jiawen Tian, Beijing (CN)

(21) Appl. No.: 19/406,426

(22) Filed: Dec. 2, 2025

(30) Foreign Application Priority Data
Mar. 5, 2025 (CN) 202510258578.5

(51) Int. Cl. B25J 15/08

(52) U.S. Cl. CPC B25J 15/08

(57) ABSTRACT

A finger module, a manipulator, and a robot are provided. The finger module includes a finger fixing base, a proximal phalanx bracket, a metacarpophalangeal joint driving assembly, a middle phalanx bracket, and a proximal interphalangeal joint driving assembly. The proximal phalanx bracket is hinged to the finger fixing base about a first axis of rotation. The metacarpophalangeal joint driving assembly is coupled to the proximal phalanx bracket and connected to the finger fixing base, to drive the proximal phalanx bracket to rotate relative to the finger fixing base. The middle phalanx bracket is hinged to the proximal phalanx bracket about a second axis of rotation. The proximal interphalangeal joint driving assembly is coupled to the proximal phalanx bracket and connected to the middle phalanx bracket, to drive the middle phalanx bracket to rotate relative to the proximal phalanx bracket about the second axis of rotation.

### CROSS-REFERENCE

The present application claims priority to Chinese Patent Application No. 202510258578.5, filed on Mar. 05, 2025, and entitled "FINGER MODULE, MANIPULATOR, AND ROBOT", which is incorporated herein by reference in its entirety.

### FIELD

Example embodiments of the present disclosure generally relate to the field of robots, and in particular, to a finger module, a manipulator, and a robot.

### BACKGROUND

A bionic robot refers to a robot that mimics a living organism and performs tasks characterized by the characteristics of the living organism. The bionic robot may mimic the morphology, structure, function, behavior, control mechanism, and the like of the living organism, so as to replace the living organism to perform specific tasks. For example, a humanoid bionic robot mimics the body movements of a human being, and thus may replace the human being to perform work with high labor intensity and high risk.

### SUMMARY

In a first aspect of the present disclosure, a finger module is provided. The finger module includes: a finger fixing base fixedly coupled to a palm module of a manipulator; a proximal phalanx bracket hinged to the finger fixing base about a first axis of rotation; a metacarpophalangeal joint driving assembly coupled to the proximal phalanx bracket and connected to the finger fixing base, and adapted to drive the proximal phalanx bracket to rotate relative to the finger fixing base about the first axis of rotation; a middle phalanx bracket hinged to the proximal phalanx bracket about a second axis of rotation; and a proximal interphalangeal joint driving assembly coupled to the proximal phalanx bracket and connected to the middle phalanx bracket, and adapted to drive the middle phalanx bracket to rotate relative to the proximal phalanx bracket about the second axis of rotation.

In some embodiments, the metacarpophalangeal joint driving assembly includes: a first sliding portion slidably connected to the proximal phalanx bracket along an extending direction of the proximal phalanx bracket; a first link arranged between the first sliding portion and the finger fixing base and located in a radial direction of the first axis of rotation, and two ends of the first link being respectively hinged to the first sliding portion and the finger fixing base; and a first linear driving mechanism coupled to the proximal phalanx bracket, and adapted to drive the first sliding portion to slide along the extending direction, to cause the proximal phalanx bracket to rotate relative to the finger fixing base about the first axis of rotation.

In some embodiments, the proximal interphalangeal joint driving assembly includes: a second sliding portion slidably connected to the proximal phalanx bracket along the extending direction of the proximal phalanx bracket; a second link arranged between the second sliding portion and the middle phalanx bracket and located in a radial direction of the second axis of rotation, and two ends of the second link being respectively hinged to the second sliding portion and the middle phalanx bracket; and a second linear driving mechanism coupled to the proximal phalanx bracket, and adapted to drive the second sliding portion to slide along the extending direction, to cause the middle phalanx bracket to rotate relative to the proximal phalanx bracket about the second axis of rotation.

In some embodiments, the first linear driving mechanism of the metacarpophalangeal joint driving assembly and the second linear driving mechanism of the proximal interphalangeal joint driving assembly each include: a lead screw rotatably coupled to the proximal phalanx bracket and extending along the extending direction, the lead screw of the first linear driving mechanism being in threaded engagement with the first sliding portion of the metacarpophalangeal joint driving assembly to drive the first sliding portion to slide along the extending direction while the lead screw rotates about an axis, and the lead screw of the second linear driving mechanism being in threaded engagement with the second sliding portion of the proximal interphalangeal joint driving assembly to drive the second sliding portion to slide along the extending direction while the lead screw rotates about an axis; and a driving motor coupled to the lead screw, and adapted to drive the lead screw to rotate about the axis.

In some embodiments, the first linear driving mechanism and/or the second linear driving mechanism each further include: a gear set arranged between an output shaft of the driving motor and the lead screw, and adapted to transmit the rotation of the output shaft to the lead screw.

In some embodiments, the proximal phalanx bracket includes: a pair of mounting plates arranged along the extending direction, and where the lead screw is arranged between the pair of mounting plates, and the driving motor is coupled to one of the pair of mounting plates.

In some embodiments, a first mounting plate of the pair of mounting plates includes: a pair of first limit grooves formed on opposite sides of the first mounting plate along an arranging direction, and extending along the extending direction, the arranging direction being perpendicular to the extending direction; and where the first sliding portion includes: a pair of first push rods respectively extending to the first link and hinged to the first link, the first push rods being arranged in the corresponding first limit grooves to slide along the extending direction under the limitation of the first limit grooves.

In some embodiments, a second mounting plate of the pair of mounting plates includes: a pair of second limit grooves formed on opposite sides of the second mounting plate along an arranging direction, and extending along the extending direction, the arranging direction being perpendicular to the extending direction; and where the second sliding portion includes: a pair of second push rods respectively extending to the second link and hinged to the second link, the second push rods being arranged in the corresponding second limit grooves to slide along the extending direction under the limitation of the second limit grooves.

In some embodiments, the proximal phalanx bracket further includes: a pair of sliding guide posts arranged between the pair of mounting plates and extending along the extending direction, and where the first sliding portion of the metacarpophalangeal joint driving assembly and/or the second sliding portion of the proximal interphalangeal joint at least partially surround the pair of sliding guide posts, so as to slide along the extending direction under the driving of the sliding guide posts.

In some embodiments, the finger module further includes a fingertip bracket hinged to the middle phalanx bracket about a third axis of rotation; and a distal fingertip joint link assembly arranged between the fingertip bracket and the proximal phalanx bracket, and adapted to drive the fingertip bracket to rotate about the third axis of rotation relative to the middle phalanx bracket as the middle phalanx bracket rotates relative to the proximal phalanx bracket.

In some embodiments, the distal fingertip joint link assembly includes: a fingertip link, two ends of the fingertip link being respectively hinged to the proximal phalanx bracket and the fingertip bracket, an end of the fingertip link close to the proximal phalanx bracket being arranged on an inner side of the second axis of rotation relative to a bending direction of the finger module, and an end of the fingertip link close to the fingertip bracket being arranged on an outer side of the third axis of rotation relative to the bending direction of the finger module.

In a second aspect of the present disclosure, a manipulator is provided. The manipulator includes: a palm module; and a plurality of finger modules according to the first aspect of the present disclosure, which are arranged at an edge of the palm module.

In a third aspect of the present disclosure, a robot is provided. The robot includes: a main body; a pair of robotic arms respectively arranged on opposite sides of the main body; and a pair of manipulators according to the second aspect of the present disclosure, which are respectively coupled to the robotic arms.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an overall structure of a finger module in a finger pad view according to some embodiments of the present disclosure;

FIG. 2 shows a schematic diagram of an overall structure of a finger module in a finger back view according to some embodiments of the present disclosure;

FIG. 3 shows a cross-sectional view of a finger module according to some embodiments of the present disclosure; and

FIG. 4 shows a schematic diagram of a finger module in a bent state according to some embodiments of the present disclosure.

### DETAILED DESCRIPTION OF EMBODIMENTS

The embodiments of the present disclosure will be described in more detail below with reference to the drawings. Although certain embodiments of the present disclosure are shown in the drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any sections/subsections provided herein are not restrictive. Various embodiments are described throughout this article, and any type of embodiment may be included under any section/subsection. In addition, the embodiments described in any section/subsection may be combined with any other embodiments described in the same section/subsection and/or different sections/subsections in any way.

In the description of the embodiments of the present disclosure, the term "include/comprise" and similar terms should be understood as open-ended inclusions, that is, "include/comprise but not limited to". The term "based on" should be understood as "based at least partially on". The term "an embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

As briefly mentioned above, a dexterous robot hand is generally composed of a palm module and a plurality of finger modules coupled to the palm module. In terms of the transmission structure, a traditional finger module generally has two solutions. One is to use a form of a coreless motor and rope drive. However, the rope drive transmission structure often has low reliability, low transmission accuracy, complex structure, high failure rate, and difficulty in maintenance. The other is to use a solution of a linear driver and link transmission. In this solution, due to problems such as a complex link structure, a large number of drivers, and a tight space layout, the number of rotating joints of a single finger is often reduced. That is, three joints of a single finger in the bending and stretching direction are simplified into two joints. However, this treatment will reduce the bionics of the finger, thus affecting the grasping posture that the finger may provide and reducing the dexterity of the finger. Moreover, the traditional solution of a linear driver and link transmission also has the problems of a long and tedious finger structure and low integration due to its high structural complexity, resulting in an excessively large size of the whole hand and low bionics.

A finger module, a manipulator, and a robot provided by the embodiments of the present disclosure solve or at least partially solve the above-mentioned problems or other potential problems in the traditional technologies. According to the finger module provided by embodiments of the present disclosure, a proximal phalanx bracket is driven by a metacarpophalangeal joint driving assembly to rotate relative to a finger fixing base about a first axis of rotation, and a middle phalanx bracket is driven by a proximal interphalangeal joint driving assembly to rotate relative to the proximal phalanx bracket about the second axis of rotation. In addition, the fingertip bracket may also move with the middle phalanx bracket under the linkage of a distal fingertip joint link assembly. Thus, the finger module is enabled to perform bending and straightening movements. As a result, the mobility of the finger module is improved, and the compactness of the layout of various transmission mechanisms inside the finger module is also improved while achieving high mobility of the finger.

According to the present disclosure, a manipulator is provided, which includes a palm module and a plurality of finger modules mounted at an edge of the palm module, the plurality of finger modules being adapted to be controlled to bend relative to the palm module. Thus, the manipulator may move and operate a target object. For example, the manipulator may perform a grasping movement by mimicking a human hand to obtain a target object.

According to embodiments of the present disclosure, a robot is further provided, which includes a main body, a pair of robotic arms arranged on opposite sides of the main body, and a pair of manipulators respectively coupled to the pair of robotic arms. The robot may adjust the position of the manipulator by controlling the movement of the main body and the robotic arm. The plurality of finger modules of the manipulator may bend or straighten relative to the palm module to perform corresponding operation movements. For example, the manipulator moves to a target object (e.g., a water cup) attachment, and the plurality of finger modules bend and at least partially surround an outer side of the target object. Thus, the target object can be grasped. Then, the robotic arm and the main body of the robot move, so that the robot may mimic human movements to move the target object. The bending and straightening of the finger module will be described more specifically below.

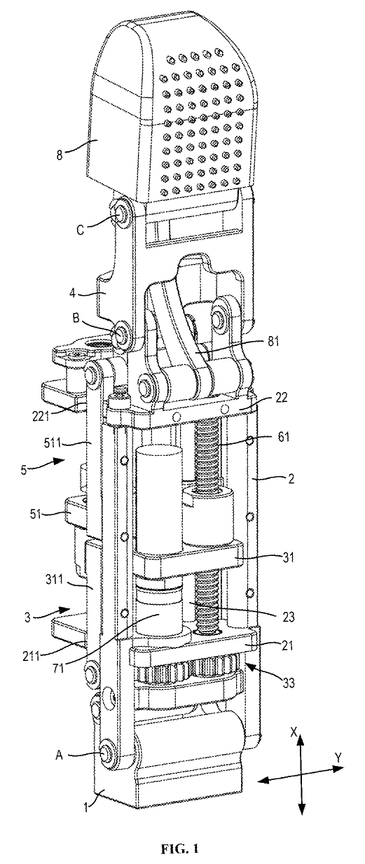

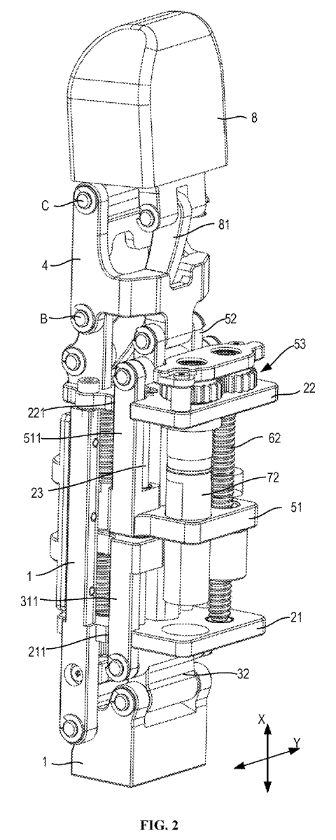

FIG. 1 shows a schematic diagram of an overall structure of a finger module in a finger pad view according to some embodiments of the present disclosure, and FIG. 2 shows a schematic diagram of an overall structure of a finger module in a finger back view according to some embodiments of the present disclosure. As shown in FIGS. 1 and 2, the finger module generally includes a finger fixing base 1, a proximal phalanx bracket 2, and a middle phalanx bracket 4 which are hinged in sequence. The finger fixing base 1 is fixedly coupled to a palm module of a manipulator. The proximal phalanx bracket 2 is arranged on a side of the finger fixing base 1 away from the palm module and extends in an extending direction X. The finger fixing base 1 and the proximal phalanx bracket 2 are connected by a first hinge shaft A, so that the finger fixing base 1 and the proximal phalanx bracket 2 may rotate about a first axis of rotation of the first hinge shaft A. The middle phalanx bracket 4 is arranged at an end of the proximal phalanx bracket 2 away from the finger fixing base 1, and an end of the middle phalanx bracket 4 is connected to the proximal phalanx bracket 2 by a second hinge shaft B, so that the middle phalanx bracket 4 may rotate relative to the proximal phalanx bracket 2 about a second axis of rotation of the second hinge shaft B. The first axis of rotation and the second axis of rotation are parallel to each other. With the rotation of the proximal phalanx bracket 2 relative to the finger fixing base 1 and the rotation of the middle phalanx bracket 4 relative to the proximal phalanx bracket 2, the finger module may bend relative to the palm module. The proximal phalanx bracket 2 is further provided with a metacarpophalangeal joint driving assembly 3 and a proximal interphalangeal joint driving assembly 5 for driving the finger module to bend. Two ends of the metacarpophalangeal joint driving assembly 3 are respectively connected to the finger fixing base 1 and the proximal phalanx bracket 2, so as to enable a metacarpophalangeal joint formed between the finger fixing base 1 and the proximal phalanx bracket 2 to bend or straighten. Two ends of the proximal interphalangeal joint driving assembly 5 are respectively connected to the proximal phalanx bracket 2 and the middle phalanx bracket 4, so as to enable a proximal interphalangeal joint formed between the proximal phalanx bracket 2 and the middle phalanx bracket 4 to bend or straighten.

In some embodiments, the metacarpophalangeal joint driving assembly 3 includes a first sliding portion 31 slidably coupled to the proximal phalanx bracket 2, a first link 32 arranged between the first sliding portion 31 and the finger fixing base 1, and a first linear driving mechanism 33 for driving the first sliding portion 31 to slide along the extending direction X of the proximal phalanx bracket 2. The first link 32 is arranged in a radial direction of the first axis of rotation, and a predetermined distance is left between the first link 32 and the extending direction X of the proximal phalanx bracket 2. One end of the first link 32 is hinged to the proximal phalanx bracket 2, and the other end of the first link 32 is hinged to the first sliding portion 31. In this way, while the first sliding portion 31 slides on the proximal phalanx bracket 2 along the extending direction X, due to a change in a spacing between the first sliding portion 31 and the finger fixing base 1, the finger fixing base 1 and the proximal phalanx bracket 2 rotate relative to each other about the first axis of rotation in order to adapt to this change, that is, the bending and straightening of the finger module about the metacarpophalangeal joint is achieved.

In some embodiments, the proximal phalanx bracket 2 includes a first mounting plate 21 arranged at an end of the proximal phalanx bracket 2 close to the finger fixing base 1 in the extending direction X and a second mounting plate 22 arranged at an end of the proximal phalanx bracket 2 close to the middle phalanx bracket 4 in the extending direction X. The first sliding portion 31 is arranged between the first mounting plate 21 and the second mounting plate 22. The first sliding portion 31 further includes at least one pair of first push rods 311, and the first push rods 311 respectively extend toward the finger fixing base 1 and are rotatably coupled to two ends of the first link 32. Correspondingly, the first mounting plate 21 is provided with first limit grooves 211 in pairs. The pair of first limit grooves 211 are formed on opposite sides of the first mounting plate 21 along an arranging direction Y perpendicular to the extending direction X, and each first limit groove 211 is arranged to extend along the extending direction X of the proximal phalanx bracket 2. The pair of first limit grooves 211 respectively at least partially accommodate the corresponding first link 32 to pass through, and limit the first link 32 to slide along the extending direction X. With the guiding effect of the first limit grooves 211 on the first push rods 311, the first sliding portion 31 may stably slide relative to the proximal phalanx bracket 2 along the extending direction X.

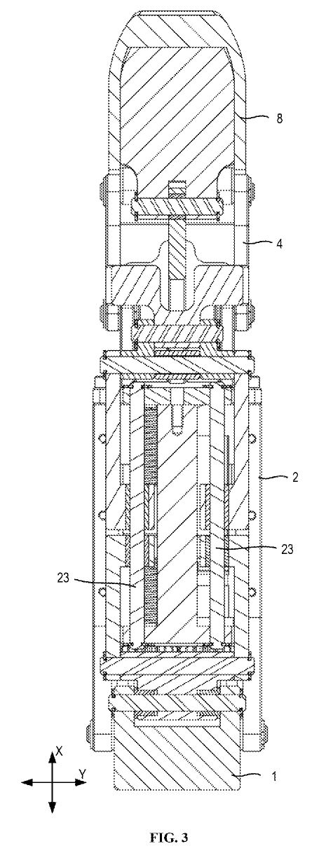

FIG. 3 shows a cross-sectional view of a finger module according to some embodiments of the present disclosure. As shown in FIG. 3, in some embodiments, sliding guide posts 23 arranged in pairs are further arranged between the first mounting plate 21 and the second mounting plate 22. An axial direction of each sliding guide post 23 is parallel to the extending direction X of the proximal phalanx bracket 2. The first sliding portion 31 may be sleeved on the pair of sliding guide posts 23, and slide along the extending direction X under the guiding action of the sliding guide posts 23. The sliding fit between the sliding guide posts 23 and the first sliding portion 31 may improve the strength of the finger module, reduce the interference of lateral force on the finger module, and improve the stability of the bending of the finger module. In some other embodiments, the first sliding portion 31 may also be slidably connected to the proximal phalanx bracket 2 by means of a slideway, a limit hole, etc., which will not be repeated in the present disclosure.

As shown in FIG. 1, in some embodiments, the first linear driving mechanism 33 may include a lead screw 61 rotatably coupled to the proximal phalanx bracket 2 and a driving motor 71 for driving the lead screw 61 to rotate about its own axis. An axial direction of the lead screw 61 is parallel to the extending direction X of the proximal phalanx bracket 2. The lead screw 61 passes through the first sliding portion 31 and is in threaded engagement with the first sliding portion 31. While the lead screw 61 is driven by the driving motor 71 to rotate about its own axis, the first sliding portion 31 may slide along the extending direction X through the threaded engagement between the lead screw 61 and the first sliding portion 31. In some embodiments, the connection structure between the lead screw 61 and the first sliding portion 31 may be a ball screw connection structure, which may reduce the friction between the lead screw 61 and the first sliding portion 31, thereby improving the stability of the sliding of the first sliding portion 31. By controlling the rotation angle of the lead screw 61 driven by the driving motor 71, the sliding distance of the first sliding portion 31 may be accurately controlled, thereby controlling the bending angle of the metacarpophalangeal joint. It should be understood that in some other embodiments, the lead screw 61 may also be any appropriate mechanism that may output linear power, such as a linear motor, a cylinder, etc.

In some embodiments, the lead screw 61 may be arranged between the first mounting plate 21 and the second mounting plate 22, and two ends of the lead screw 61 are respectively rotatably connected to the first mounting plate 21 and the second mounting plate 22. The driving motor 71 is coupled to the first mounting plate 21, and an output shaft of the driving motor 71 may transmit power to the lead screw 61 through a gear set. In this way, the volume occupation of the first linear driving mechanism 33 may be reduced, the integration inside the finger module may be improved, and the volume of the finger module may be reduced.

As shown in FIG. 2, in some embodiments, the proximal interphalangeal joint driving assembly 5 includes a second sliding portion 51 slidably coupled to the proximal phalanx bracket 2, a second link 52 arranged on a side of the second sliding portion 51 facing the middle phalanx bracket 4, and a second linear driving mechanism 53 for driving the second sliding portion 51 to slide on the proximal phalanx bracket 2 along the extending direction X. The second link 52 is arranged in a radial direction of the second axis of rotation, and is spaced apart from the extending direction X of the proximal phalanx bracket 2 by a predetermined distance. An end of the second link 52 facing the second sliding portion 51 is hinged to the second sliding portion 51, and an end of the second link 52 facing the middle phalanx bracket 4 is hinged to the middle phalanx bracket 4. In this way, if the second sliding portion 51 slides on the proximal phalanx bracket 2 along the extending direction X and approaches or moves away from the middle phalanx bracket 4, due to the hinge connections between the second link 52 and the middle phalanx bracket 4 and between the second link 52 and the second sliding portion 51, the proximal phalanx bracket 2 and the middle phalanx bracket 4 need to rotate relative to each other about the second axis of rotation to match the sliding of the second sliding portion 51. That is, the bending and straightening of the proximal interphalangeal joint is achieved.

As shown in FIG. 2, in some embodiments, the second sliding portion 51 is arranged between the first mounting plate 21 and the second mounting plate 22, and the second sliding portion 51 includes at least one pair of second push rods 511, and the second push rods 511 extend toward the second link 52 and are rotatably connected to the second link 52. The second mounting plate 22 is further provided with second limit grooves 221 in pairs. The pair of second limit grooves 221 are respectively formed on opposite sides of the second mounting plate 22 along an arranging direction Y perpendicular to the extending direction X, and are adapted to partially accommodate the second push rods 511, so that the second push rods 511 may slide along the extending direction X in the second limit grooves 221. As shown in FIG. 3, in some embodiments, the second sliding portion 51 may be sleeved on the sliding guide posts 23 and slide along the extending direction X more stably under the guiding action of the sliding guide posts 23. The cooperation between the second sliding portion 51 and the sliding guide posts 23 further improves the lateral force resistance of the finger module, especially the proximal interphalangeal joint of the finger module.

Similar to the structure of the first linear driving mechanism 33, the second linear driving mechanism 53 may include a lead screw 62 and a driving motor 72 for driving the lead screw 62 to rotate about its own axis. Two ends of the lead screw 62 are respectively coupled to the first mounting plate 21 and the second mounting plate 22, and an axial direction of the lead screw 62 is parallel to the extending direction X of the proximal phalanx bracket 2. The second sliding portion 51 is sleeved on an outer side of the lead screw 62 and is in threaded engagement with the lead screw 62. While the lead screw 62 is driven by the driving motor 72 to rotate about its own axis, the second sliding portion 51 may slide along the extending direction X through the threaded engagement between the lead screw 62 and the second sliding portion 51. In some embodiments, the driving motor 72 is coupled to the second mounting plate 22, and a gear set is further arranged between an output shaft of the driving motor 72 and the lead screw 62. Through the transmission of the gear set, the driving motor 72 may drive the lead screw 62 to rotate about its own axis.

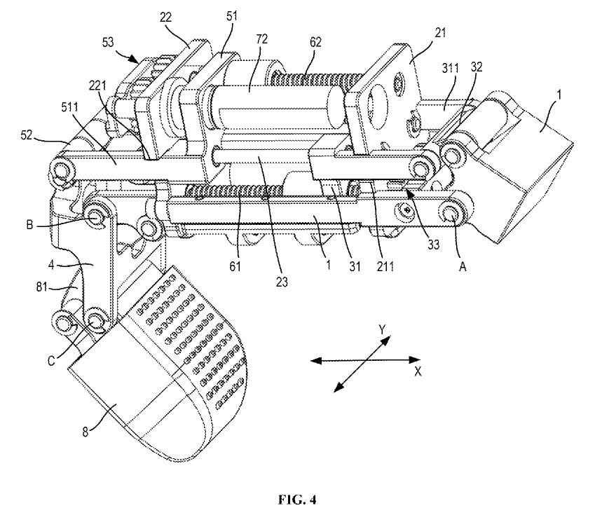

FIG. 4 shows a schematic diagram of a finger module in a bent state according to some embodiments of the present disclosure. As shown in FIG. 4, if the first sliding portion 31 is driven by the first linear driving mechanism 33 to slide in a direction toward the first mounting plate 21, at this point, the finger fixing base 1 and the proximal phalanx bracket 2 are pushed by the first link 32 to rotate about the first axis of rotation, and thus the metacarpophalangeal joint of the finger module changes from a straight state to a bent state. If the second linear driving mechanism 53 pushes the second sliding portion 51 to slide in a direction toward the second mounting plate 22, the proximal phalanx bracket 2 and the middle phalanx bracket 4 are pushed by the second link 52 to rotate about the second axis of rotation, and thus the proximal interphalangeal joint of the finger module changes from a straight state to a bent state. In this way, the finger module performs some predetermined operation tasks, such as grasping a target object, by bending.

In some embodiments, an end of the middle phalanx bracket 4 away from the proximal phalanx bracket 2 is further provided with a fingertip bracket 8, and the fingertip bracket 8 is hinged to the middle phalanx bracket 4 by a third hinge shaft C. The fingertip bracket 8 may rotate relative to the middle phalanx bracket 4 about a third axis of rotation of the third hinge shaft C. The fingertip bracket 8 is further coupled to a distal fingertip joint link assembly, and the distal fingertip joint link assembly is arranged between the proximal phalanx bracket 2 and the fingertip bracket 8. The distal fingertip joint link assembly is adapted to drive the fingertip bracket 8 to rotate about the third axis of rotation relative to the middle phalanx bracket 4 as the middle phalanx bracket 4 rotates relative to the proximal phalanx bracket 2. Specifically, the distal fingertip joint link assembly includes a fingertip link 81, and two ends of the fingertip link 81 are respectively hinged to the proximal phalanx bracket 2 and the fingertip bracket 8. An end of the fingertip link 81 close to the proximal phalanx bracket 2 is arranged on an inner side of the second axis of rotation relative to a bending direction of the finger module, and an end of the fingertip link 81 close to the fingertip bracket 8 is arranged on an outer side of the third axis of rotation relative to the bending direction of the finger module. When the proximal interphalangeal joint of the finger module bends (that is, the middle phalanx bracket 4 rotates relative to the proximal phalanx bracket 2 about the second axis of rotation), at this point, the distal fingertip joint also bends under the pushing of the fingertip link 81, so that the bending range of the finger module may be increased, thereby improving the grasping ability of the manipulator.

In some embodiments, an inner side of the fingertip bracket 8 facing the bending direction is further provided with a non-slip pad. The non-slip pad may be made of a flexible material such as silica gel or rubber. The non-slip pad may increase the friction between the finger module and the target object, and may provide buffering between the finger module and the target object.

According to the finger module provided by embodiments of the present disclosure, the proximal phalanx bracket is driven by the metacarpophalangeal joint driving assembly to rotate relative to the finger fixing base about the first axis of rotation, and the middle phalanx bracket is driven by the proximal interphalangeal joint driving assembly to rotate relative to the proximal phalanx bracket about the second axis of rotation. In addition, the fingertip bracket may also move with the middle phalanx bracket under the linkage of the distal fingertip joint link assembly. Thus, the finger module is enabled to perform bending and straightening movements. As a result, the mobility of the finger module is improved, and the compactness of the layout of various transmission mechanisms inside the finger module is also improved while achieving high mobility of the finger.

The implementations of the present disclosure have been described above, and the above description is illustrative, non-exhaustive, and is not intended to limit the disclosed implementations. Many modifications and variations will be apparent to those of ordinary skill in the art without departing from the scope and spirit of the described implementations. The terms used herein are chosen to best explain the principles of the implementations, the practical applications, or the improvements to the technology in the market, or to enable other persons of ordinary skill in the art to understand the implementations disclosed herein.

1. A finger module, comprising:
a finger fixing base fixedly coupled to a palm module of a manipulator;
a proximal phalanx bracket hinged to the finger fixing base about a first axis of rotation;
a metacarpophalangeal joint driving assembly coupled to the proximal phalanx bracket and connected to the finger fixing base, and adapted to drive the proximal phalanx bracket to rotate relative to the finger fixing base about the first axis of rotation;
a middle phalanx bracket hinged to the proximal phalanx bracket about a second axis of rotation; and
a proximal interphalangeal joint driving assembly coupled to the proximal phalanx bracket and connected to the middle phalanx bracket, and adapted to drive the middle phalanx bracket to rotate relative to the proximal phalanx bracket about the second axis of rotation.

2. The finger module of claim 1, wherein
the metacarpophalangeal joint driving assembly comprises:
a first sliding portion slidably connected to the proximal phalanx bracket along an extending direction of the proximal phalanx bracket;
a first link arranged between the first sliding portion and the finger fixing base and located in a radial direction of the first axis of rotation, two ends of the first link being respectively hinged to the first sliding portion and the finger fixing base; and
a first linear driving mechanism coupled to the proximal phalanx bracket, and adapted to drive the first sliding portion to slide along the extending direction, to cause the proximal phalanx bracket to rotate relative to the finger fixing base about the first axis of rotation; and/or
the proximal interphalangeal joint driving assembly comprises:
a second sliding portion slidably connected to the proximal phalanx bracket along an extending direction of the proximal phalanx bracket;
a second link arranged between the second sliding portion and the middle phalanx bracket and located in a radial direction of the second axis of rotation, two ends of the second link being respectively hinged to the second sliding portion and the middle phalanx bracket; and
a second linear driving mechanism coupled to the proximal phalanx bracket, and adapted to drive the second sliding portion to slide along the extending direction, to cause the middle phalanx bracket to rotate relative to the proximal phalanx bracket about the second axis of rotation.

3. The finger module of claim 2, wherein the first linear driving mechanism of the metacarpophalangeal joint driving assembly and the second linear driving mechanism of the proximal interphalangeal joint driving assembly each comprise:
a lead screw rotatably coupled to the proximal phalanx bracket and extending along the extending direction, the lead screw of the first linear driving mechanism being in threaded engagement with the first sliding portion of the metacarpophalangeal joint driving assembly to drive the first sliding portion to slide along the extending direction while the lead screw rotates about an axis, and the lead screw of the second linear driving mechanism being in threaded engagement with the second sliding portion of the proximal interphalangeal joint driving assembly to drive the second sliding portion to slide along the extending direction while the lead screw rotates about an axis; and
a driving motor coupled to the lead screw, and adapted to drive the lead screw to rotate about the axis.

4. The finger module of claim 3, wherein the first linear driving mechanism and/or the second linear driving mechanism each further comprise:
a gear set arranged between an output shaft of the driving motor and the lead screw, and adapted to transmit the rotation of the output shaft to the lead screw.

5. The finger module of claim 3, wherein the proximal phalanx bracket comprises: a pair of mounting plates arranged along the extending direction, and
wherein the lead screw is arranged between the pair of mounting plates, and the driving motor is coupled to one of the pair of mounting plates.

6. The finger module of claim 5, wherein the pair of mounting plates comprises a first mounting plate, and the first mounting plate comprises:
a pair of first limit grooves formed on opposite sides of the first mounting plate along an arranging direction, and extending along the extending direction, the arranging direction being perpendicular to the extending direction; and
wherein the first sliding portion comprises:
a pair of first push rods respectively extending to the first link and hinged to the first link, the first push rods being arranged in the corresponding first limit grooves to slide along the extending direction under the limitation of the first limit grooves.

7. The finger module of claim 5, wherein the pair of mounting plates comprises a second mounting plate, and the second mounting plate comprises:
a pair of second limit grooves formed on opposite sides of the second mounting plate along an arranging direction, and extending along the extending direction, the arranging direction being perpendicular to the extending direction; and
wherein the second sliding portion comprises:
a pair of second push rods respectively extending to the second link and hinged to the second link, the second push rods being arranged in the corresponding second limit grooves to slide along the extending direction under the limitation of the second limit grooves.

8. The finger module of claim 5, wherein the proximal phalanx bracket further comprises:
a pair of sliding guide posts arranged between the pair of mounting plates and extending along the extending direction, and
wherein the first sliding portion of the metacarpophalangeal joint driving assembly and/or the second sliding portion of the proximal interphalangeal joint at least partially surround the pair of sliding guide posts, so as to slide along the extending direction under the guiding action of the sliding guide posts.

9. The finger module of claims claim 1, further comprising a fingertip bracket hinged to the middle phalanx bracket about a third axis of rotation; and
a distal fingertip joint link assembly arranged between the fingertip bracket and the proximal phalanx bracket, and adapted to drive the fingertip bracket to rotate about the third axis of rotation relative to the middle phalanx bracket as the middle phalanx bracket rotates relative to the proximal phalanx bracket.

10. The finger module of claim 9, wherein the distal fingertip joint link assembly comprises:
a fingertip link, two ends of the fingertip link being respectively hinged to the proximal phalanx bracket and the fingertip bracket, an end of the fingertip link close to the proximal phalanx bracket being arranged on an inner side of the second axis of rotation relative to a bending direction of the finger module, and an end of the fingertip link close to the fingertip bracket being arranged on an outer side of the third axis of rotation relative to the bending direction of the finger module.

11. A manipulator, comprising:
a palm module; and
a plurality of finger modules arranged at an edge of the palm module, and each finger module comprising:
a finger fixing base fixedly coupled to a palm module of a manipulator;
a proximal phalanx bracket hinged to the finger fixing base about a first axis of rotation;
a metacarpophalangeal joint driving assembly coupled to the proximal phalanx bracket and connected to the finger fixing base, and adapted to drive the proximal phalanx bracket to rotate relative to the finger fixing base about the first axis of rotation;
a middle phalanx bracket hinged to the proximal phalanx bracket about a second axis of rotation; and
a proximal interphalangeal joint driving assembly coupled to the proximal phalanx bracket and connected to the middle phalanx bracket, and adapted to drive the middle phalanx bracket to rotate relative to the proximal phalanx bracket about the second axis of rotation.

12. The manipulator of claim 11, wherein
the metacarpophalangeal joint driving assembly comprises:
a first sliding portion slidably connected to the proximal phalanx bracket along an extending direction of the proximal phalanx bracket;
a first link arranged between the first sliding portion and the finger fixing base and located in a radial direction of the first axis of rotation, two ends of the first link being respectively hinged to the first sliding portion and the finger fixing base; and
a first linear driving mechanism coupled to the proximal phalanx bracket, and adapted to drive the first sliding portion to slide along the extending direction, to cause the proximal phalanx bracket to rotate relative to the finger fixing base about the first axis of rotation; and/or
the proximal interphalangeal joint driving assembly comprises:
a second sliding portion slidably connected to the proximal phalanx bracket along an extending direction of the proximal phalanx bracket;
a second link arranged between the second sliding portion and the middle phalanx bracket and located in a radial direction of the second axis of rotation, two ends of the second link being respectively hinged to the second sliding portion and the middle phalanx bracket; and
a second linear driving mechanism coupled to the proximal phalanx bracket, and adapted to drive the second sliding portion to slide along the extending direction, to cause the middle phalanx bracket to rotate relative to the proximal phalanx bracket about the second axis of rotation.

13. The manipulator of claim 12, wherein the first linear driving mechanism of the metacarpophalangeal joint driving assembly and the second linear driving mechanism of the proximal interphalangeal joint driving assembly each comprise:
a lead screw rotatably coupled to the proximal phalanx bracket and extending along the extending direction, the lead screw of the first linear driving mechanism being in threaded engagement with the first sliding portion of the metacarpophalangeal joint driving assembly to drive the first sliding portion to slide along the extending direction while the lead screw rotates about an axis, and the lead screw of the second linear driving mechanism being in threaded engagement with the second sliding portion of the proximal interphalangeal joint driving assembly to drive the second sliding portion to slide along the extending direction while the lead screw rotates about an axis; and
a driving motor coupled to the lead screw, and adapted to drive the lead screw to rotate about the axis.

14. The manipulator of claim 13, wherein the first linear driving mechanism and/or the second linear driving mechanism each further comprise:
a gear set arranged between an output shaft of the driving motor and the lead screw, and adapted to transmit the rotation of the output shaft to the lead screw.

15. The finger module of claim 13, wherein the proximal phalanx bracket comprises: a pair of mounting plates arranged along the extending direction, and
wherein the lead screw is arranged between the pair of mounting plates, and the driving motor is coupled to one of the pair of mounting plates.

16. The finger module of claim 15, wherein the pair of mounting plates comprises a first mounting plate, and the first mounting plate comprises:
a pair of first limit grooves formed on opposite sides of the first mounting plate along an arranging direction, and extending along the extending direction, the arranging direction being perpendicular to the extending direction; and
wherein the first sliding portion comprises:
a pair of first push rods respectively extending to the first link and hinged to the first link, the first push rods being arranged in the corresponding first limit grooves to slide along the extending direction under the limitation of the first limit grooves.

17. The finger module of claim 15, wherein the pair of mounting plates comprises a second mounting plate, and the second mounting plate comprises:
a pair of second limit grooves formed on opposite sides of the second mounting plate along an arranging direction, and extending along the extending direction, the arranging direction being perpendicular to the extending direction; and
wherein the second sliding portion comprises:
a pair of second push rods respectively extending to the second link and hinged to the second link, the second push rods being arranged in the corresponding second limit grooves to slide along the extending direction under the limitation of the second limit grooves.

18. The finger module of claim 15, wherein the proximal phalanx bracket further comprises:
a pair of sliding guide posts arranged between the pair of mounting plates and extending along the extending direction, and
wherein the first sliding portion of the metacarpophalangeal joint driving assembly and/or the second sliding portion of the proximal interphalangeal joint at least partially surround the pair of sliding guide posts, so as to slide along the extending direction under the guiding action of the sliding guide posts.

19. The finger module of claims claim 11, further comprising a fingertip bracket hinged to the middle phalanx bracket about a third axis of rotation; and
a distal fingertip joint link assembly arranged between the fingertip bracket and the proximal phalanx bracket, and adapted to drive the fingertip bracket to rotate about the third axis of rotation relative to the middle phalanx bracket as the middle phalanx bracket rotates relative to the proximal phalanx bracket.

20. A robot, comprising:
a main body;
a pair of robotic arms respectively arranged on opposite sides of the main body; and
a pair of manipulators respectively coupled to the robotic arms, wherein each manipulator comprising:
a palm module; and
a plurality of finger modules arranged at an edge of the palm module, and each finger module comprising:
a finger fixing base fixedly coupled to a palm module of a manipulator;
a proximal phalanx bracket hinged to the finger fixing base about a first axis of rotation;
a metacarpophalangeal joint driving assembly coupled to the proximal phalanx bracket and connected to the finger fixing base, and adapted to drive the proximal phalanx bracket to rotate relative to the finger fixing base about the first axis of rotation;
a middle phalanx bracket hinged to the proximal phalanx bracket about a second axis of rotation; and
a proximal interphalangeal joint driving assembly coupled to the proximal phalanx bracket and connected to the middle phalanx bracket, and adapted to drive the middle phalanx bracket to rotate relative to the proximal phalanx bracket about the second axis of rotation.
